(19) United States
(12) Patent Application Publication
(10) Pub. No.: US 2025/0378529 A1
(43) Pub. Date: Dec. 11, 2025

(54) IMAGE SUPER-RESOLUTION METHOD AND APPARATUS

(71) Applicant: Beijing Zitiao Network Technology Co., Ltd., Beijing (CN)

(72) Inventor: Hang DONG, Beijing (CN)

(21) Appl. No.: 18/876,650

(22) PCT Filed: Dec. 8, 2023
(86) PCT No.: PCT/CN2023/137339

§ 371 Date: Dec. 18, 2024

(30) Foreign Application Priority Data
Dec. 28, 2022 (CN) 202211699926.5

(51) Int. Cl. G06T 3/4046; G06T 3/4053

(52) U.S. Cl. CPC G06T 3/4046; G06T 3/4053

(57) ABSTRACT

Embodiments include an image super-resolution method and apparatus. The method includes: performing feature extraction on a to-be-super-resolved image to obtain a first image feature; processing the first image feature by using a channel attention network to obtain a second image feature, where the channel attention network includes multi-level cascaded local channel self-attention layers, any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature based on the combined feature; and generating, based on the second image feature and the to-be-super-resolved image, a super-resolution image corresponding to the to-be-super-resolved image.

### CROSS-REFERENCE TO RELATED APPLICATION(S)

The present application is a U.S. National Stage application under 35 U.S.C. § 371 of International Application No. PCT/CN2023/137339, as filed on Dec. 8, 2023, which is based on and claims priority to Chinese Patent Application No. 202211699926.5, filed on Dec. 28, 2022, titled “IMAGE SUPER-RESOLUTION METHOD AND APPARATUS”, the disclosure of the applications are incorporated by reference herein in their entireties.

### TECHNICAL FIELD

The present application relates to the field of image processing technology and, in particular, to an image super-resolution method and apparatus.

### BACKGROUND

The image super-resolution technology is a technology for restoring a high-resolution image from a low-resolution image. Since an image super-resolution service has become a key service in image quality enhancement, the image super-resolution technology is one of current research hotspots in the field of image processing.

### SUMMARY

The embodiments of the present application provide the following technical solutions:

In a first aspect, an embodiment of the present application provides an image super-resolution method, including:
performing feature extraction on a to-be-super-resolved image to obtain a first image feature;
processing the first image feature by using a channel attention network to obtain a second image feature, where the channel attention network includes multi-level cascaded local channel self-attention layers, and any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature of the local channel self-attention layer based on the combined feature; and
generating, based on the second image feature and the to-be-super-resolved image, a super-resolution image corresponding to the to-be-super-resolved image.

As an optional implementation of the embodiments of the present application, the separately recalibrating the plurality of first feature blocks based on the channel self-attention mechanism, to obtain the second feature block corresponding to each first feature block includes:
flattening the first feature block into a two-dimensional feature to obtain a flattened feature;
encoding the flattened feature by using a first fully connected layer, a second fully connected layer, and a third fully connected layer, respectively, to obtain a first encoded feature, a second encoded feature, and a third encoded feature;
obtaining a channel attention matrix based on the first encoded feature and the second encoded feature; recalibrating the third encoded feature based on the channel attention matrix, to obtain a recalibrated feature; and
unflattening the recalibrated feature, to obtain the second feature block corresponding to the first feature block.

As an optional implementation of the embodiments of the present application, the obtaining the channel attention matrix based on the first encoded feature and the second encoded feature includes:
performing transposition on the second encoded feature to obtain a fourth encoded feature; and
obtaining the channel attention matrix based on the first encoded feature, the fourth encoded feature, and a normalization exponential function.

As an optional implementation of the embodiments of the present application, convolution kernel sizes of the first fully connected layer, the second fully connected layer, and the third fully connected layer are all different.

As an optional implementation of the embodiments of the present application, any one of the local channel self-attention layers is further configured to: before outputting the output feature of the local channel self-attention layer, process the output feature of the local channel self-attention layer by using a feedforward network (FFN).

As an optional implementation of the embodiments of the present application, the generating, based on the second image feature and the to-be-super-resolved image, the super-resolution image corresponding to the to-be-super-resolved image includes:
upsampling the second image feature to obtain an upsampled feature; and
generating, based on the upsampled feature and the to-be-super-resolved image, the super-resolution image corresponding to the to-be-super-resolved image.

As an optional implementation of the embodiments of the present application, the upsampling the second image feature includes:
upsampling the second image feature in a pixel shuffle upsampling manner.

As an optional implementation of the embodiments of the present application, the generating, based on the upsampled feature and the to-be-super-resolved image, the super-resolution image corresponding to the to-be-super-resolved image includes:
performing linear interpolation on the to-be-super-resolved image to obtain an interpolated image; and
adding and fusing the interpolated image and the upsampled feature, to obtain the super-resolution image corresponding to the to-be-super-resolved image.

As an optional implementation of the embodiments of the present application, the performing feature extraction on the to-be-super-resolved image to obtain the first image feature includes:
performing convolution processing on the to-be-super-resolved image to obtain the first image feature.

In a second aspect, an embodiment of the present application provides an image super-resolution apparatus, including:
an extraction unit, configured to perform feature extraction on a to-be-super-resolved image to obtain a first image feature;
a calibration unit, configured to process the first image feature by using a channel attention network to obtain a second image feature, where the channel attention network includes multi-level cascaded local channel self-attention layers, and any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature of the local channel self-attention layer based on the combined feature; and
a generation unit, configured to generate, based on the second image feature and the to-be-super-resolved image, a super-resolution image corresponding to the to-be-super-resolved image.

As an optional implementation of the embodiments of the present application, the calibration unit is specifically configured to flatten the first feature block into a two-dimensional feature to obtain a flattened feature; encode the flattened feature by using a first fully connected layer, a second fully connected layer, and a third fully connected layer, respectively, to obtain a first encoded feature, a second encoded feature, and a third encoded feature; obtain a channel attention matrix based on the first encoded feature and the second encoded feature; recalibrate the third encoded feature based on the channel attention matrix, to obtain a recalibrated feature; and unflatten the recalibrated feature, to obtain the second feature block corresponding to the first feature block.

As an optional implementation of the embodiments of the present application, the calibration unit is specifically configured to perform transposition on the second encoded feature to obtain a fourth encoded feature; and obtain the channel attention matrix based on the first encoded feature, the fourth encoded feature, and a normalization exponential function.

As an optional implementation of the embodiments of the present application, convolution kernel sizes of the first fully connected layer, the second fully connected layer, and the third fully connected layer are all different. As an optional implementation of the embodiments of the present application, the calibration unit is specifically configured to process the combined feature by using a feedforward network (FFN) to obtain a feedforward feature, and obtain the output feature based on the feedforward feature.

As an optional implementation of the embodiments of the present application, the generation unit is specifically configured to upsample the second image feature to obtain an upsampled feature; and generate, based on the upsampled feature and the to-be-super-resolved image, the super-resolution image corresponding to the to-be-super-resolved image.

As an optional implementation of the embodiments of the present application, the generation unit is specifically configured to upsample the second image feature in a pixel shuffle upsampling manner.

As an optional implementation of the embodiments of the present application, the generation unit is specifically configured to perform linear interpolation on the to-be-super-resolved image to obtain an interpolated image, and add and fuse the interpolated image and the upsampled feature to obtain the super-resolution image corresponding to the to-be-super-resolved image.

As an optional implementation of the embodiments of the present application, the extraction unit is specifically configured to perform convolution processing on the to-be-super-resolved image to obtain the first image feature.

In a third aspect, an embodiment of the present application provides an electronic device, including: a memory and a processor, where the memory is configured to store a computer program, and the processor is configured to, when calling the computer program, cause the electronic device to perform the image super-resolution method according to the first aspect or any optional implementation of the first aspect.

In a fourth aspect, an embodiment of the present application provides a computer-readable storage medium, where a computer program is stored on the computer-readable storage medium. When the computer program is executed by a computing device, the computing device is caused to perform the image super-resolution method according to the first aspect or any optional implementation of the first aspect.

In a fifth aspect, an embodiment of the present application provides a computer program product. When the computer program product runs on a computer, the computer is caused to perform the image super-resolution method according to the first aspect or any optional implementation of the first aspect.

### BRIEF DESCRIPTION OF THE DRAWINGS

The drawings herein are incorporated into and constitute a part of the specification, illustrate the embodiments consistent with the present application, and are used together with the specification to explain the principles of the present application.

In order to more clearly illustrate the technical solutions in the embodiments of the present application or in the related art, the following briefly introduces the drawings required for describing the embodiments or the related art. Apparently, for those of ordinary skill in the art, other drawings can be obtained based on these drawings without creative efforts.

FIG. 1 is a first flowchart of steps of an image super-resolution method according to an embodiment of the present application;

FIG. 2 is a first structural diagram of an image super-resolution network model according to an embodiment of the present application;

FIG. 3 is a second flowchart of steps of an image super-resolution method according to an embodiment of the present application;

FIG. 4 is a second structural diagram of an image super-resolution network model according to an embodiment of the present application;

FIG. 5 is a third flowchart of steps of an image super-resolution method according to an embodiment of the present application;

FIG. 6 is a third structural diagram of an image super-resolution network model according to an embodiment of the present application;

FIG. 7 is a fourth flowchart of steps of an image super-resolution method according to an embodiment of the present application;

FIG. 8 is a fourth structural diagram of an image super-resolution network model according to an embodiment of the present application;

FIG. 9 is a structural diagram of an image super-resolution apparatus according to an embodiment of the present application; and

FIG. 10 is a hardware structural diagram of an electronic device according to an embodiment of the present application.

### DETAILED DESCRIPTION OF EMBODIMENTS

In order to more clearly understand the above objectives, features, and advantages of the present application, the solutions of the present application will be further described below. It should be noted that, the embodiments of the present application and the features in the embodiments may be combined with each other without conflict.

Many specific details are set forth in the following description to facilitate a full understanding of the present application, but the present application may also be implemented in other ways different from those described herein; apparently, the embodiments in the specification are merely a part of the embodiments of the present application, but not all of the embodiments.

It should be noted that, in order to clearly describe the technical solutions of the embodiments of the present application, in the embodiments of the present application, the terms “first” and “second” are used to distinguish between the same or similar items with basically the same functions and roles, and those skilled in the art can understand that the terms “first” and “second” are not intended to limit the number and execution order. For example, the first image feature and the second image feature are merely used to distinguish different features, rather than limiting the order of the features.

In the embodiments of the present application, words such as “exemplary” or “for example” are used to represent examples, instances, or explanations. Any embodiment or design solution described as “exemplary” or “for example” in the embodiments of the present application should not be interpreted as being more preferable or advantageous than other embodiments or design solutions. Rather, using the words “exemplary” or “for example” are intended to present the related concepts in a specific manner. In addition, in the description of the embodiments of the present application, unless otherwise specified, “multiple” means two or more.

At present, a mainstream image super-resolution model is an image super-resolution model based on a convolutional neural network (CNN). However, most of CNN-based image super-resolution models use a stack of residual blocks to construct a backbone network. In order to obtain a large receptive field in a feature extraction process, usually a very deep network structure is stacked, which results in a large number of model parameters, prone to overfitting in a training process, and at the same time, some unnatural artifacts and aliasing may be generated. In order to solve the problem of the large number of parameters of the CNN model, the related art proposes to obtain a large receptive field by spatial self-attention or channel self-attention. However, because an amount of computation of the spatial self-attention is in a sub-exponential relationship with image resolution, an image super-resolution model including a spatial self-attention module has an extremely huge amount of computation and a very slow running speed when implementing a high-resolution image. Although an image super-resolution model including a channel self-attention module processes a high-resolution image at a high speed, it pays too little attention to local information, it is difficult to restore detailed texture, and an image obtained through super-resolution is very blurred.

In view of this, the present application provides an image super-resolution method and apparatus, which are used to better restore texture details of an image while ensuring speed of image super-resolution.

In the image super-resolution method provided by the embodiments of the present application, when super-resolution is performed on a to-be-super-resolved image, first, feature extraction is performed on the to-be-super-resolved image to obtain a first image feature, then the first image feature is processed by using a channel attention network to obtain a second image feature, and then a super-resolution image corresponding to the to-be-super-resolved image is generated based on the second image feature and the to-be-super-resolved image. Since in the embodiments of the present application, a large receptive field is obtained based on a channel self-attention mechanism, thereby implementing image super-resolution, an amount of computation of the image super-resolution method provided by the embodiments of the present application does not increase exponentially with an increase in image resolution. Therefore, the embodiments of the present application can ensure speed of image super-resolution first. In addition, because the channel attention network in the embodiments of the present application includes multi-level cascaded local channel self-attention layers, and any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature of the local channel self-attention layer based on the combined feature, when the embodiments of the present application recalibrate an image feature based on the channel self-attention mechanism, local information of the to-be-super-resolved image can be more effectively used, thereby better restoring texture details of the to-be-super-resolved image. In conclusion, the image super-resolution method provided by the embodiments of the present application can better restore texture details of an image while ensuring speed of image super-resolution.

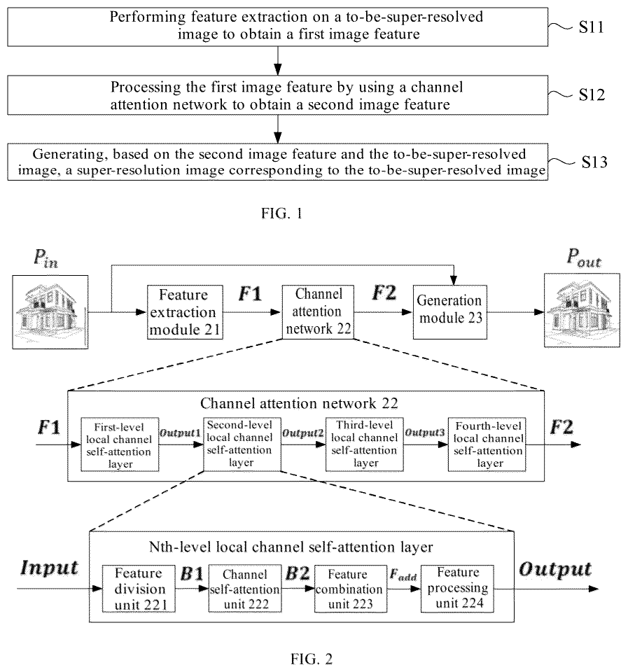

The embodiment of the present application provides an image super-resolution method. As shown in FIG. 1, the image super-resolution method includes the following steps.
S11: Perform feature extraction on a to-be-super-resolved image to obtain a first image feature.

The to-be-super-resolved image in the embodiment of the present application refers to a low-resolution image corresponding to a desired high-resolution image. The to-be-super-resolved image may be an image of any resolution and any format. For example, the to-be-super-resolved image may be an RGB image with a resolution of 960*540.

In the embodiments of the present application, a feature extraction manner of performing feature extraction on the to-be-super-resolved image is not limited, as long as the feature extraction can be performed on the to-be-super-resolved image.

As an optional implementation of the embodiments of the present application, the above step S11 (performing feature extraction on the to-be-super-resolved image to obtain the first image feature) includes: performing convolution processing on the to-be-super-resolved image to obtain the first image feature. Exemplarily, a convolution kernel size of a convolutional layer configured to perform convolution processing on the to-be-super-resolved image may be 3*3, and a stride may be 1.

In some embodiments, a length of the first image feature is the same as a length of the to-be-super-resolved image, and a width of the first image feature is the same as a width of the to-be-super-resolved image. That is, if a dimension of the to-be-super-resolved image is [C₀, H, W], a dimension of the first image feature is [C₁, H, W].
S12: Process the first image feature by using a channel attention network to obtain a second image feature.

The channel attention network includes multi-level cascaded local channel self-attention layers, and any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature of the local channel self-attention layer based on the combined feature.

Specifically, since the multi-level cascaded local channel self-attention layers of the channel attention network are cascaded, and an input of the channel attention network is the first image feature, the input feature of the first-level local channel self-attention layer of the channel attention network is the first image feature, and input features of the second-level local channel self-attention layer and subsequent local channel self-attention layers are output features of the previous channel attention layer. That is,

$${Input}_{n} = \{ \begin{matrix}first image feature ; & n = 1 \\ {Output}_{n - 1} ; & n \neq 1\end{matrix}$$

where Inputₙ is an input feature of the nth-level channel attention layer, and Outputₙ₋₁ is an output feature of the (n-1)th-level channel attention layer.

In some embodiments, dimensions of the multiple first feature blocks obtained by the local channel self-attention layer dividing the input feature thereof are the same. That is, the local channel self-attention layer divides the input feature thereof into multiple first feature blocks with the same dimension.

In some embodiments, a quantity of feature channels of each of the multiple first feature blocks is the same as a quantity of feature channels of the first image feature. That is, if a dimension of the first image feature is [C₁, H, W], a dimension of the first feature block is [C₁, p, p], and a number of the first feature blocks is N=H/p×W/p.

The operation of the local channel self-attention layer on the input feature is: first, dividing the input feature into multiple first feature blocks, then separately recalibrating the multiple first feature blocks based on the channel self-attention mechanism to obtain a second feature block corresponding to each first feature block, combining second feature blocks corresponding to the multiple first feature blocks to obtain a combined feature, and obtaining an output feature of the local channel self-attention layer based on the combined feature.

Recalibrating the multiple first feature blocks separately based on the channel self-attention mechanism does not change the dimension of the feature. Therefore, a dimension of the second image feature is the same as a dimension of the first image feature.
S13: Generate, based on the second image feature and the to-be-super-resolved image, a super-resolution image corresponding to the to-be-super-resolved image.

FIG. 2 is referred to. In FIG. 2, an example in which the channel attention network includes four levels of local channel self-attention layers is shown. As shown in FIG. 2, a video super-resolution model configured to implement the image super-resolution method shown in FIG. 1 includes a feature extraction module 21, a channel attention network 22, and an image generation module 23.

The feature extraction module 21 is configured to perform feature extraction on a to-be-super-resolved image Pᵢₙ to obtain a first image feature F1.

The channel attention network 22 includes a first-level local channel self-attention layer, a second-level local channel self-attention layer, a third-level local channel self-attention layer, and a fourth-level local channel self-attention layer. An input feature of the first-level local channel self-attention layer is the first image feature F1, an input feature of the second-level local channel self-attention layer is an output feature Output1 of the first-level local channel self-attention layer, an input feature of the third-level local channel self-attention layer is an output feature Output2 of the second-level local channel self-attention layer, an input feature of the fourth-level local channel self-attention layer is an output feature Output3 of the third-level local channel self-attention layer, and an output feature of the fourth-level local channel self-attention layer is the second image feature F2. Any one of the local channel self-attention layers includes a feature division unit 221, a channel self-attention unit 222, a feature combination unit 223, and a feature processing unit 224. The feature division unit 221 is configured to divide an input feature Input into multiple first feature blocks B1, the channel self-attention unit 222 is configured to separately recalibrate the multiple first feature blocks B1 based on a channel self-attention mechanism to obtain a second feature block B2 corresponding to each first feature block B1, the feature combination unit 223 is configured to combine second feature blocks B2 corresponding to the multiple first feature blocks B1 to obtain a combined feature F_{add}, and the feature processing unit 224 is configured to obtain an output feature Output of the local channel self-attention layer based on the combined feature F_{add}.

The image generation module 23 is configured to generate, based on the second image feature F2 and the to-be-super-resolved image Pᵢₙ, a super-resolution image Pout corresponding to the to-be-super-resolved image Pᵢₙ.

In the image super-resolution method provided by the embodiment of the present application, when super-resolution is performed on a to-be-super-resolved image, first, feature extraction is performed on the to-be-super-resolved image to obtain a first image feature, then the first image feature is processed by using a channel attention network to obtain a second image feature, and then a super-resolution image corresponding to the to-be-super-resolved image is generated based on the second image feature and the to-be-super-resolved image. Since in the embodiments of the present application, a large receptive field is obtained based on a channel self-attention mechanism, thereby implementing image super-resolution, an amount of computation of the image super-resolution method provided by the embodiments of the present application does not increase exponentially with an increase in image resolution. Therefore, the embodiments of the present application can ensure speed of image super-resolution first. In addition, because the channel attention network in the embodiments of the present application includes multi-level cascaded local channel self-attention layers, and any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature of the local channel self-attention layer based on the combined feature, when the embodiments of the present application recalibrate an image feature based on the channel self-attention mechanism, local information of the to-be-super-resolved image can be more effectively used, thereby better restoring texture details of the to-be-super-resolved image. In conclusion, the image super-resolution method provided by the embodiments of the present application can better restore texture details of an image while ensuring speed of image super-resolution.

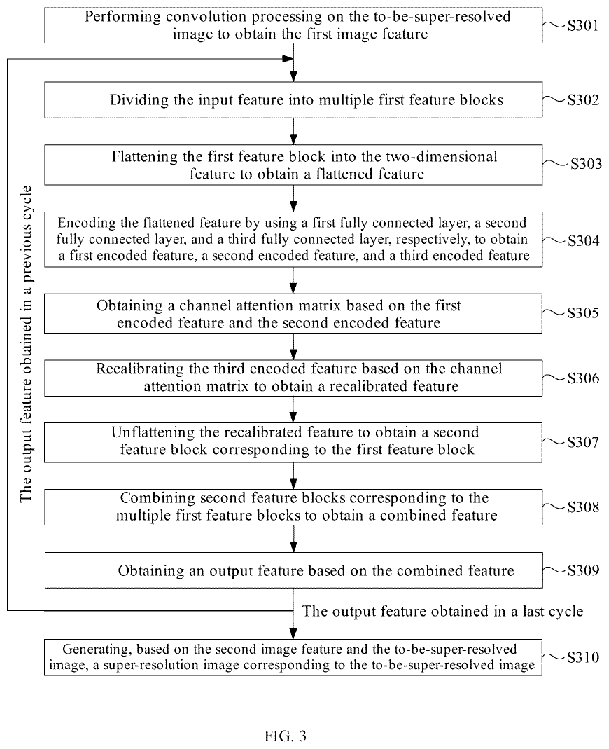

As an expansion and refinement of the above embodiments, the embodiments of the present application provide another image super-resolution method. As shown in FIG. 3, the image super-resolution method includes the following steps S301 to S310.
S301: Perform convolution processing on the to-be-super-resolved image to obtain the first image feature.

Exemplarily, a convolution kernel size of a convolutional layer configured to perform convolution processing on the to-be-super-resolved image may be 3*3, and a stride may be 1.

The following steps S302 to S309 are cyclically performed based on the number of layers of the local channel self-attention layers included in the channel attention network.
S302: Divide an input feature into multiple first feature blocks.

In a first cycle, the input feature is the first image feature. In another cycle other than the first cycle, the input feature is an output feature obtained in a previous cycle. That is,

$${Input}_{n} = \{ \begin{matrix}first image feature ; & n = 1 \\ {Output}_{n - 1} ; & n \neq 1\end{matrix}$$

where Inputₙ is an input feature when the step S302 is performed for the nth time, and Outputₙ₋₁ is an output feature obtained when the step S309 is performed for the (n-1)th time.
S303: Flatten the first feature block into a two-dimensional feature to obtain a flattened feature.

In some embodiments, a length of the flattened feature is a product of a length and a width of the input feature block, and a width of the flattened feature is a number of feature channels of the input feature block. That is, if a dimension of the input feature block is [C₁, p, p], a dimension of the flattened feature is [p², C₁].
S304: Encode the flattened feature by using a first fully connected layer, a second fully connected layer, and a third fully connected layer, respectively, to obtain a first encoded feature, a second encoded feature, and a third encoded feature.

In some embodiments, convolution kernel sizes of the first fully connected layer, the second fully connected layer, and the third fully connected layer are all different.
S305: Obtain a channel attention matrix based on the first encoded feature and the second encoded feature.

In some embodiments, implementation of the above step S305 (obtaining the channel attention matrix based on the first encoded feature and the second encoded feature) includes the following step a and step b.
Step a: Perform transposition on the second encoded feature to obtain a fourth encoded feature.

That is, all feature points of the second encoded feature are mirror flipped around a ray starting from a feature point in the first row and the first column and extending in a lower right direction at an angle of 45°.

Exemplarily, the second encoded feature is K, the fourth encoded feature is L, and

$$K = \{ \begin{matrix}t 11 & t 12 & t 13 \\ t 21 & t 22 & t 23 \\ t 31 & t 32 & t 33\end{matrix} \}$$

Then, there is:

$$L = {K}^{T} = \{ \begin{matrix}t 11 & t 21 & t 31 \\ t 12 & t 22 & t 32 \\ t 13 & t 23 & t 33\end{matrix} \}$$

Step b: Obtain the channel attention matrix based on the first encoded feature, the fourth encoded feature, and a normalization exponential function (Softmax function).

If the channel attention matrix is AM, the first encoded feature is Q, and the second encoded feature is K, there is:

$$AM = soft max ( \frac{{K}^{T} Q}{σ} ) = soft max ( \frac{LQ}{σ} )$$

where σ is a constant parameter of the normalization exponential function.
S306: Recalibrate the third encoded feature based on the channel attention matrix to obtain a recalibrated feature.

In some embodiments, the recalibrating the third encoded feature based on the channel attention matrix to obtain the recalibrated feature includes:
calculating an outer product of the third encoded feature and the channel attention matrix to obtain the recalibrated feature.

If the channel attention matrix is AM, the third encoded feature is V, and the recalibrated feature is AR, there is:

$$A R = V \times A M$$

S307: Unflatten the recalibrated feature to obtain the second feature block corresponding to the first feature block.

That is, the recalibrated feature is unflattened into the second feature block with the same dimension as the first feature block.
S308: Combine second feature blocks corresponding to the multiple first feature blocks to obtain a combined feature.

That is, the second feature blocks corresponding to the multiple first feature blocks are combined into an image feature with the same dimension as the first image feature.
S309: Obtain an output feature based on the combined feature.

The above steps S302 to S309 are cyclically performed based on the number of layers of the local channel self-attention layers included in the channel attention network, and the output feature obtained in a last cycle is used as the second image feature.
S310: Generate, based on the second image feature and the to-be-super-resolved image, a super-resolution image corresponding to the to-be-super-resolved image.

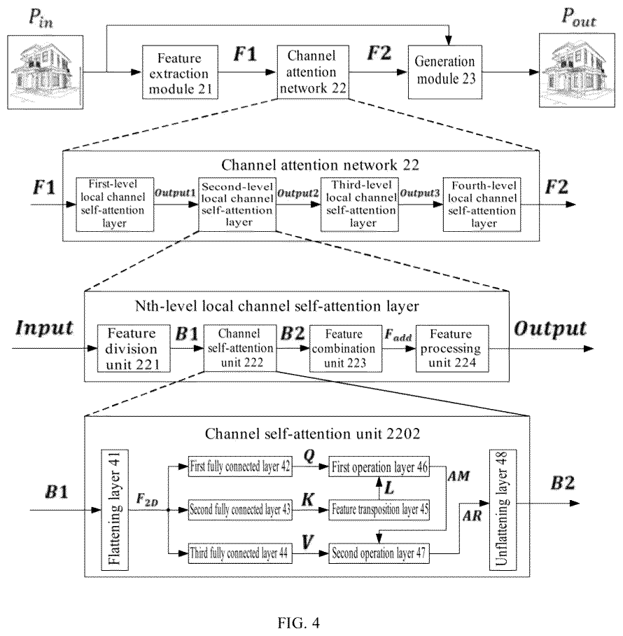

Exemplarily, as shown in FIG. 4, based on the image super-resolution model shown in FIG. 2, in the image super-resolution model configured to implement the image super-resolution method shown in FIG. 3, the channel self-attention unit 222 of each level of local channel self-attention layer includes a flattening layer 41, a first fully connected layer 42, a second fully connected layer 43, a third fully connected layer 44, a feature transposition layer 45, a first operation layer 46, a second operation layer 47, and an unflattening layer 48. The flattening layer 41 is configured to flatten the first feature block B1 inputted into the channel self-attention unit 222 into the flattened feature F_{2D}, and input the flattened feature F_{2D} into the first fully connected layer 42, the second fully connected layer 43, and the third fully connected layer 44, respectively. The first fully connected layer 42, the second fully connected layer 43, and the third fully connected layer 44 are configured to encode the two-dimensional feature F_{2D}, to obtain a first encoded feature Q, a second encoded feature K, and a third encoded feature V, respectively. The feature transposition layer 45 is configured to perform transposition on the second encoded feature K to obtain a fourth encoded feature L. The first operation layer 46 is configured to obtain the channel attention matrix AM based on the first encoded feature Q, the fourth encoded feature L, and a normalization exponential function. The second operation layer 47 is configured to recalibrate the third encoded feature based on the channel attention matrix, to obtain a recalibrated feature AR. The unflattening layer 48 is configured to unflatten the recalibrated feature AR to obtain the second feature block B2 corresponding to the first feature block B1. Functions of other functional modules in the image super-resolution model shown in FIG. 4 are the same as those of the embodiment shown in FIG. 2. For ease of description, details are not described herein.

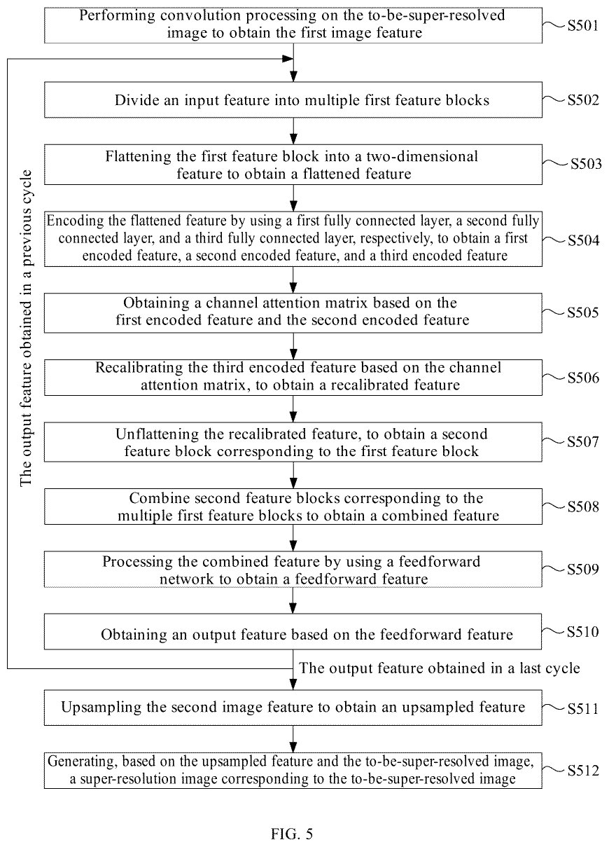

As an expansion and refinement of the above embodiments, the embodiments of the present application provide another image super-resolution method. As shown in FIG. 5, the image super-resolution method includes the following steps S501 to S512.
S501: Perform convolution processing on the to-be-super-resolved image to obtain the first image feature.

The following steps S502 to S510 are repeatedly performed based on the number of layers of the local channel self-attention layers included in the channel attention network.
S502: Divide an input feature into multiple first feature blocks.

When step S502 is executed in a first cycle, the input feature is the first image feature. When step S502 is executed in another cycle other than the first cycle, the input feature is an output feature obtained in a previous cycle.
S503: Flatten the first feature block into a two-dimensional feature to obtain a flattened feature.
S504: Encode the flattened feature by using a first fully connected layer, a second fully connected layer, and a third fully connected layer, respectively, to obtain a first encoded feature, a second encoded feature, and a third encoded feature.

In some embodiments, convolution kernel sizes of the first fully connected layer, the second fully connected layer, and the third fully connected layer are all different.
S505: Obtain a channel attention matrix based on the first encoded feature and the second encoded feature.
S506: Recalibrate the third encoded feature based on the channel attention matrix to obtain a recalibrated feature.
S507: Unflattening the recalibrated feature to obtain a second feature block corresponding to the first feature block.

That is, the recalibrated feature is unflattened into the second feature block with the same dimension as the first feature block.
S508: Combine second feature blocks corresponding to the multiple first feature blocks to obtain a combined feature.

That is, the second feature blocks corresponding to the multiple first feature blocks are combined into an image feature with the same dimension as the first image feature.
S509: Process the combined feature by using a feedforward network (FFN) to obtain a feedforward feature. In the foregoing steps S502 to S508, the local channel self-attention layer may recalibrate the first feature block based on channel information inside the first feature block, which effectively uses the channel information inside the first feature block, but less channel information between adjacent first feature blocks is used. In the embodiment of the present application, after the second feature blocks corresponding to the multiple first feature blocks are combined to obtain the combined feature, the combined feature is further processed by using the feedforward network. Therefore, in the embodiment of the present application, the channel information between adjacent first feature blocks may be further captured by using the feedforward network, and then the channel information between adjacent first feature blocks of the first image feature is more effectively used for image restoration. Therefore, the texture details of the to-be-super-resolved image can be better restored in the embodiment of the present application.
S510: Obtain an output feature based on the feedforward feature.

The following steps S502 to S510 are cyclically performed based on the number of layers of the local channel self-attention layers included in the channel attention network, and the output feature obtained in a last cycle is used as the second image feature.
S511: Upsample the second image feature to obtain an upsampled feature.

In some embodiments, the above step S511 (upsampling the second image feature to obtain the upsampled feature) includes:
upsampling the second image feature in a pixel shuffle upsampling manner.
S512: Generate, based on the upsampled feature and the to-be-super-resolved image, a super-resolution image corresponding to the to-be-super-resolved image.

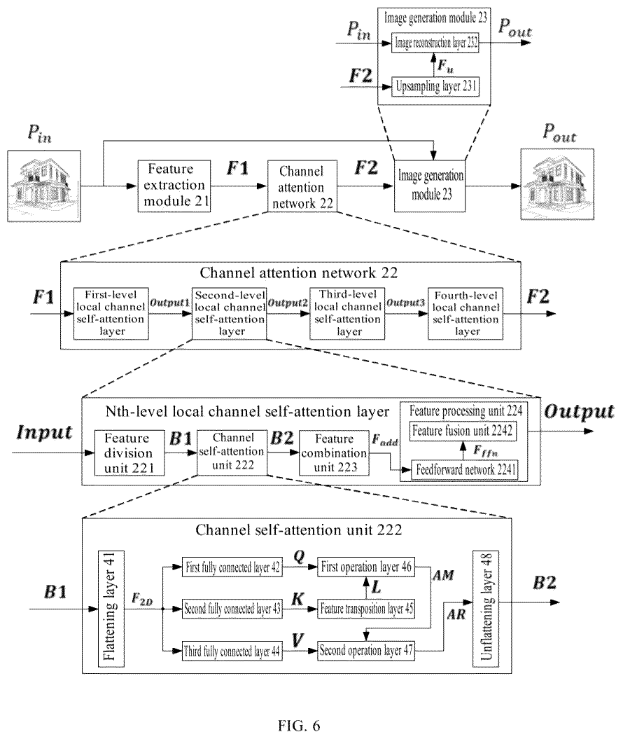

Exemplarily, as shown in FIG. 6, based on the image super-resolution model shown in FIG. 4, the image generation module 23 in the image super-resolution model configured to implement the image super-resolution method shown in FIG. 5 includes an upsampling layer 231 and an image reconstruction layer 232. The upsampling layer 231 is configured to upsample the second image feature F2 to obtain an upsampled feature Fᵤ, and the image reconstruction layer 232 is configured to generate, based on the upsampled feature Fᵤ and the to-be-super-resolved image Pᵢₙ, the super-resolution image Pₒᵤₜ corresponding to the to-be-super-resolved image Pᵢₙ. The feature processing unit 224 includes a feedforward network 2241 and a feature fusion unit 2242. The feedforward network 2241 is configured to process the combined feature F_{add} to obtain a feedforward feature F_{ffn}. The feature fusion unit 2242 is configured to obtain an output feature Output based on the feedforward feature F_{ffn}. Functions of other functional modules in the image super-resolution model shown in FIG. 6 are the same as those of the embodiment shown in FIG. 4. For ease of description, details are not described herein.

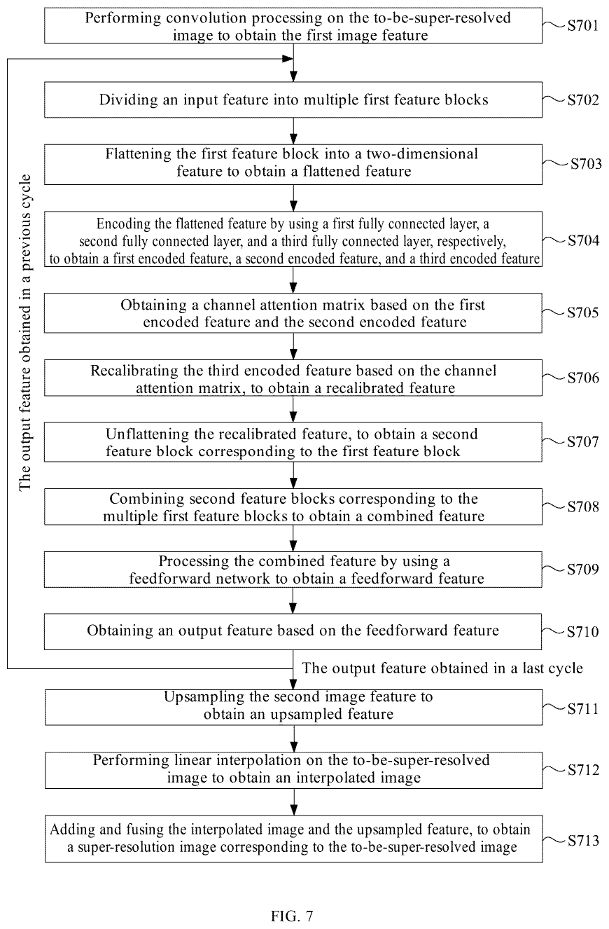

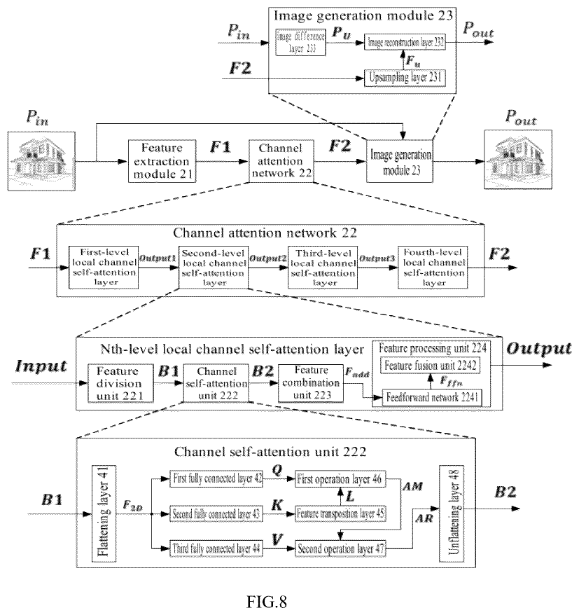

As an expansion and refinement of the above embodiments, the embodiments of the present application provide another image super-resolution method. As shown in FIG. 7, the image super-resolution method includes the following steps S701 to S713.
S701: Perform convolution processing on the to-be-super-resolved image to obtain the first image feature.

The following steps S702 to S710 are cyclically performed for the first image feature based on the number of local channel self-attention layers included in the channel attention network.
S702: Divide an input feature into multiple first feature blocks.

When step S702 is executed in a first cycle, the input feature is the first image feature. When step S702 is executed in another cycle other than the first cycle, the input feature is an output feature obtained in a previous cycle.
S703: Flatten the first feature block into a two-dimensional feature to obtain a flattened feature.
S704: Encode the flattened feature by using a first fully connected layer, a second fully connected layer, and a third fully connected layer, respectively, to obtain a first encoded feature, a second encoded feature, and a third encoded feature.
S705: Obtain a channel attention matrix based on the first encoded feature and the second encoded feature.
S706: Recalibrate the third encoded feature based on the channel attention matrix to obtain a recalibrated feature.
S707: Unflattening the recalibrated feature to obtain a second feature block corresponding to the first feature block.

That is, the recalibrated feature is unflattened into the second feature block with the same dimension as the first feature block.
S708: Combine second feature blocks corresponding to the multiple first feature blocks to obtain a combined feature.

That is, the second feature blocks corresponding to the multiple first feature blocks are combined into an image feature with the same dimension as the first image feature.
S709: Process the combined feature by using a feedforward network to obtain a feedforward feature.
S710: Obtain an output feature based on the feedforward feature.

The above steps S702 to S710 are cyclically performed based on the number of layers of the local channel self-attention layers included in the channel attention network, and the output feature obtained in a last cycle is used as the second image feature.
S711: Upsample the second image feature to obtain an upsampled feature.
S712: Perform linear interpolation on the to-be-super-resolved image to obtain an interpolated image.

In some embodiments, the performing linear interpolation on the to-be-super-resolved image to obtain the interpolated image includes:
performing bilinear interpolation on the to-be-super-resolved image to obtain the interpolated image.
S713: Add and fuse the interpolated image and the upsampled feature to obtain the super-resolution image corresponding to the to-be-super-resolved image.

Exemplarily, as shown in FIG. 8, based on the image super-resolution model shown in FIG. 6, the image generation module 23 in the image super-resolution model configured to implement the image super-resolution method shown in FIG. 7 further includes an image difference layer 233. The image difference layer 233 is configured to perform linear interpolation on the to-be-super-resolved image Pᵢₙ to obtain an interpolated image P_{U}, and the image reconstruction layer 232 is specifically configured to add and fuse the interpolated image P_{U} and the upsampled feature Fu to obtain the super-resolution image Pₒᵤₜ corresponding to the to-be-super-resolved image Pᵢₙ. Functions of other functional modules in the image super-resolution model shown in FIG. 8 are the same as those of the embodiment shown in FIG. 6. For ease of description, details are not described herein.

Based on the same inventive concept, as an implementation of the above method, the embodiments of the present application further provide an image super-resolution apparatus. The apparatus embodiment corresponds to the foregoing method embodiments. For ease of reading, the apparatus embodiment does not describe details in the foregoing method embodiments one by one. However, it should be clear that the image super-resolution apparatus in the embodiment can correspondingly implement all content in the foregoing method embodiments.

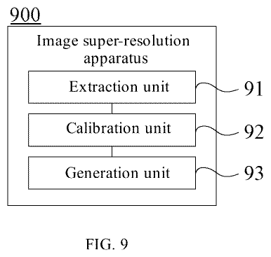

The embodiment of the present application provides an image super-resolution apparatus. FIG. 9 is a structural diagram of the image super-resolution apparatus. As shown in FIG. 9, the image super-resolution apparatus 900 includes an extraction unit 91, a calibration unit 92, and a generation unit 93.

The extraction unit 91 is configured to perform feature extraction on a to-be-super-resolved image to obtain a first image feature.

The calibration unit 92 is configured to process the first image feature by using a channel attention network to obtain a second image feature. The channel attention network includes multi-level cascaded local channel self-attention layers, and any one of the local channel self-attention layers is configured to divide an input feature of the local channel self-attention layer into multiple first feature blocks, separately recalibrate the multiple first feature blocks based on a channel self-attention mechanism to obtain a second feature block corresponding to each first feature block, combine second feature blocks corresponding to the multiple first feature blocks to obtain a combined feature, and obtain an output feature of the local channel self-attention layer based on the combined feature.

The generation unit 93 is configured to generate, based on the second image feature and the to-be-super-resolved image, a super-resolution image corresponding to the to-be-super-resolved image.

As an optional implementation of the embodiments of the present application, the calibration unit 92 is specifically configured to flatten the first feature block into a two-dimensional feature to obtain a flattened feature; encode the flattened feature by using a first fully connected layer, a second fully connected layer, and a third fully connected layer, respectively, to obtain a first encoded feature, a second encoded feature, and a third encoded feature; obtain a channel attention matrix based on the first encoded feature and the second encoded feature; recalibrate the third encoded feature based on the channel attention matrix to obtain a recalibrated feature; and unflatten the recalibrated feature to obtain the second feature block corresponding to the first feature block.

As an optional implementation of the embodiments of the present application, the calibration unit 92 is specifically configured to perform transposition on the second encoded feature to obtain a fourth encoded feature; and obtain the channel attention matrix based on the first encoded feature, the fourth encoded feature, and a normalization exponential function.

As an optional implementation of the embodiments of the present application, convolution kernel sizes of the first fully connected layer, the second fully connected layer, and the third fully connected layer are all different. As an optional implementation of the embodiments of the present application, the calibration unit 92 is specifically configured to process the combined feature by using a feedforward network (FFN) to obtain a feedforward feature, and obtain the output feature based on the feedforward feature.

As an optional implementation of the embodiments of the present application, the generation unit 93 is specifically configured to upsample the second image feature to obtain an upsampled feature, and generate, based on the upsampled feature and the to-be-super-resolved image, the super-resolution image corresponding to the to-be-super-resolved image.

As an optional implementation of the embodiments of the present application, the generation unit 93 is specifically configured to upsample the second image feature in a pixel shuffle upsampling manner.

As an optional implementation of the embodiments of the present application, the generation unit 93 is specifically configured to perform linear interpolation on the to-be-super-resolved image to obtain an interpolated image, and add and fuse the interpolated image and the upsampled feature to obtain the super-resolution image corresponding to the to-be-super-resolved image.

As an optional implementation of the embodiments of the present application, the extraction unit 91 is specifically configured to perform convolution processing on the to-be-super-resolved image to obtain the first image feature.

The image super-resolution apparatus provided in this embodiment may perform the image super-resolution method provided in the foregoing method embodiment. Implementation principles and technical effects of the image super-resolution apparatus are similar to those of the image super-resolution method, and are not described herein again.

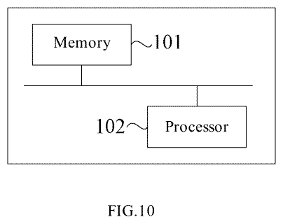

Based on the same inventive concept, the embodiments of the present application further provide an electronic device. FIG. 10 is a structural diagram of an electronic device according to an embodiment of the present application. As shown in FIG. 10, the electronic device provided in this embodiment includes a memory 101 and a processor 102. The memory 101 is configured to store a computer program. The processor 102 is configured to, when calling the computer program, perform the image super-resolution method provided in the foregoing embodiments.

Based on the same inventive concept, an embodiment of the present application further provides a computer-readable storage medium. A computer program is stored on the computer-readable storage medium, and when the computer program is executed by a computing device, the computing device is caused to perform the image super-resolution method provided in the foregoing embodiments.

Based on the same inventive concept, an embodiment of the present application further provides a computer program product. When the computer program product runs on a computing device, the computing device is caused to perform the image super-resolution method provided in the foregoing embodiments.

Those skilled in the art should understand that the embodiments of the present application may be provided as a method, a system, or a computer program product. Therefore, the present application may be implemented in the form of an entire hardware embodiment, an entire software embodiment, or an embodiment combining software and hardware. In addition, the present application may be implemented in the form of a computer program product implemented on one or more computer-usable storage medium including computer-usable program codes therein.

The processor may be a central processing unit (Central Processing Unit, CPU), and may also be another general-purpose processor, a digital signal processor (Digital Signal Processor, DSP), an application-specific integrated circuit (Application Specific Integrated Circuit, ASIC), a field-programmable gate array (Field-Programmable Gate Array, FPGA) or another programmable logic device, a discrete gate or transistor logic device, a discrete hardware component, or the like. The general-purpose processor may be a microprocessor or the processor may also be any conventional processor or the like.

The memory may include a non-permanent memory, a random access memory (RAM), and/or a non-volatile memory in a computer-readable medium, such as a read-only memory (ROM) or a flash memory (flash RAM). The memory is an example of the computer-readable medium.

The computer-readable medium includes a permanent and non-permanent, removable and non-removable storage medium. The storage medium may implement information storage by any method or technology, and the information may be computer-readable instructions, data structures, program modules, or other data. Examples of the computer storage medium include, but are not limited to, a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic disk storage, or another magnetic storage device, or any other non-transmission medium, which may be used for storing information that can be accessed by the computing device. According to the definition in this specification, the computer-readable medium does not include a transitory computer-readable medium (transitory media), such as a modulated data signal and a carrier.

Finally, it should be noted that, the above embodiments are merely used to describe the technical solutions of the present application, but not to limit the present application. Although the present application has been described in detail with reference to the foregoing embodiments, those of ordinary skill in the art should understand that they can still modify the technical solutions described in the foregoing embodiments, or equivalently replace some or all of the technical features thereof. These modifications or replacements do not make the essence of the corresponding technical solutions depart from the scope of the technical solutions of the embodiments of the present application.

1. An image super-resolution method, comprising:
performing feature extraction on a to-be-super-resolved image to obtain a first image feature;
processing the first image feature by using a channel attention network to obtain a second image feature, wherein the channel attention network comprises multi-level cascaded local channel self-attention layers, and any one of the local channel self-attention layers is configured to divide an input feature of the local channel self-attention layer into a plurality of first feature blocks, separately recalibrate the plurality of first feature blocks based on a channel self-attention mechanism to obtain a second feature block corresponding to each first feature block, combine second feature blocks corresponding to the plurality of first feature blocks to obtain a combined feature, and obtain an output feature of the local channel self-attention layer based on the combined feature; and
generating, based on the second image feature and the to-be-super-resolved image, a super-resolution image corresponding to the to-be-super-resolved image.

2. The method according to claim 1, wherein the separately recalibrating the plurality of first feature blocks based on the channel self-attention mechanism, to obtain the second feature block corresponding to each first feature block comprises:
flattening the first feature block into a two-dimensional feature to obtain a flattened feature;
encoding the flattened feature by using a first fully connected layer, a second fully connected layer, and a third fully connected layer, respectively, to obtain a first encoded feature, a second encoded feature, and a third encoded feature;
obtaining a channel attention matrix based on the first encoded feature and the second encoded feature;
recalibrating the third encoded feature based on the channel attention matrix, to obtain a recalibrated feature; and
unflattening the recalibrated feature, to obtain the second feature block corresponding to the first feature block.

3. The method according to claim 2, wherein the obtaining the channel attention matrix based on the first encoded feature and the second encoded feature comprises:
performing transposition on the second encoded feature to obtain a fourth encoded feature; and
obtaining the channel attention matrix based on the first encoded feature, the fourth encoded feature, and a normalization exponential function.

4. The method according to claim 2, wherein convolution kernel sizes of the first fully connected layer, the second fully connected layer, and the third fully connected layer are all different.

5. The method according to claim 1, wherein the obtaining the output feature of the local channel self-attention layer based on the combined feature comprises:
processing the combined feature by using a feedforward network to obtain a feedforward feature; and
obtaining the output feature based on the feedforward feature.

6. The method according to claim 1, wherein the generating, based on the second image feature and the to-be-super-resolved image, the super-resolution image corresponding to the to-be-super-resolved image comprises:
upsampling the second image feature to obtain an upsampled feature; and
generating, based on the upsampled feature and the to-be-super-resolved image, the super-resolution image corresponding to the to-be-super-resolved image.

7. The method according to claim 6, wherein the upsampling the second image feature comprises:
upsampling the second image feature in a pixel shuffle upsampling manner.

8. The method according to claim 6, wherein the generating, based on the upsampled feature and the to-be-super-resolved image, the super-resolution image corresponding to the to-be-super-resolved image comprises:
performing linear interpolation on the to-be-super-resolved image to obtain an interpolated image; and
adding and fusing the interpolated image and the upsampled feature, to obtain the super- resolution image corresponding to the to-be-super-resolved image.

9. The method according to claim 1, wherein the performing feature extraction on the to-be-super-resolved image to obtain the first image feature comprises:
performing convolution processing on the to-be-super-resolved image to obtain the first image feature.

10. (canceled)

11. An electronic device, comprising: a memory and a processor, wherein the memory is configured to store a computer program, and the processor is configured to, when calling the computer program, cause the electronic device to perform an image super-resolution method comprising:
performing feature extraction on a to-be-super-resolved image to obtain a first image feature;
processing the first image feature by using a channel attention network to obtain a second image feature, wherein the channel attention network comprises multi-level cascaded local channel self-attention layers, and any one of the local channel self-attention layers is configured to divide an input feature of the local channel self-attention layer into a plurality of first feature blocks, separately recalibrate the plurality of first feature blocks based on a channel self-attention mechanism to obtain a second feature block corresponding to each first feature block, combine second feature blocks corresponding to the plurality of first feature blocks to obtain a combined feature, and obtain an output feature of the local channel self-attention layer based on the combined feature; and
generating, based on the second image feature and the to-be-super-resolved image, a super-resolution image corresponding to the to-be-super-resolved image.

12. A non-transitory computer-readable storage medium, wherein a computer program is stored on the computer-readable storage medium, and the computer program, when executed by a computing device, causes the computing device to perform an image super-resolution method according to comprising:
performing feature extraction on a to-be-super-resolved image to obtain a first image feature;
processing the first image feature by using a channel attention network to obtain a second image feature, wherein the channel attention network comprises multi-level cascaded local channel self-attention layers, and any one of the local channel self-attention layers is configured to divide an input feature of the local channel self-attention layer into a plurality of first feature blocks, separately recalibrate the plurality of first feature blocks based on a channel self-attention mechanism to obtain a second feature block corresponding to each first feature block, combine second feature blocks corresponding to the plurality of first feature blocks to obtain a combined feature, and obtain an output feature of the local channel self-attention layer based on the combined feature; and
generating, based on the second image feature and the to-be-super-resolved image, a super-resolution image corresponding to the to-be-super-resolved image.

13-14. (canceled)

15. The non-transitory computer-readable storage medium according to claim 12, wherein the separately recalibrating the plurality of first feature blocks based on the channel self-attention mechanism, to obtain the second feature block corresponding to each first feature block comprises:
flattening the first feature block into a two-dimensional feature to obtain a flattened feature;
encoding the flattened feature by using a first fully connected layer, a second fully connected layer, and a third fully connected layer, respectively, to obtain a first encoded feature, a second encoded feature, and a third encoded feature;
obtaining a channel attention matrix based on the first encoded feature and the second encoded feature;
recalibrating the third encoded feature based on the channel attention matrix, to obtain a recalibrated feature; and
unflattening the recalibrated feature, to obtain the second feature block corresponding to the first feature block.

16. The non-transitory computer-readable storage medium according to claim 15, wherein the obtaining the channel attention matrix based on the first encoded feature and the second encoded feature comprises:
performing transposition on the second encoded feature to obtain a fourth encoded feature; and
obtaining the channel attention matrix based on the first encoded feature, the fourth encoded feature, and a normalization exponential function.

17. The non-transitory computer-readable storage medium according to claim 15, wherein convolution kernel sizes of the first fully connected layer, the second fully connected layer, and the third fully connected layer are all different.

18. The non-transitory computer-readable storage medium according to claim 12, wherein the obtaining the output feature of the local channel self-attention layer based on the combined feature comprises:
processing the combined feature by using a feedforward network to obtain a feedforward feature; and
obtaining the output feature based on the feedforward feature.

19. The non-transitory computer-readable storage medium according to claim 12, wherein the generating, based on the second image feature and the to-be-super-resolved image, the super-resolution image corresponding to the to-be-super-resolved image comprises:
upsampling the second image feature to obtain an upsampled feature; and
generating, based on the upsampled feature and the to-be-super-resolved image, the super-resolution image corresponding to the to-be-super-resolved image.

20. The non-transitory computer-readable storage medium according to claim 19, wherein the upsampling the second image feature comprises:
upsampling the second image feature in a pixel shuffle upsampling manner.

21. The non-transitory computer-readable storage medium according to claim 19, wherein the generating, based on the upsampled feature and the to-be-super-resolved image, the super-resolution image corresponding to the to-be-super-resolved image comprises:
performing linear interpolation on the to-be-super-resolved image to obtain an interpolated image; and
adding and fusing the interpolated image and the upsampled feature, to obtain the super-resolution image corresponding to the to-be-super-resolved image.

22. The non-transitory computer-readable storage medium according to claim 12, wherein the performing feature extraction on the to-be-super-resolved image to obtain the first image feature comprises:
performing convolution processing on the to-be-super-resolved image to obtain the first image feature.

23. The electronic device according to claim 11, wherein the separately recalibrating the plurality of first feature blocks based on the channel self-attention mechanism, to obtain the second feature block corresponding to each first feature block comprises:
flattening the first feature block into a two-dimensional feature to obtain a flattened feature;
encoding the flattened feature by using a first fully connected layer, a second fully connected layer, and a third fully connected layer, respectively, to obtain a first encoded feature, a second encoded feature, and a third encoded feature;
obtaining a channel attention matrix based on the first encoded feature and the second encoded feature;
recalibrating the third encoded feature based on the channel attention matrix, to obtain a recalibrated feature; and
unflattening the recalibrated feature, to obtain the second feature block corresponding to the first feature block.
